(19) United States
(12) Patent Application Publication
(10) Pub. No.: US 2022/0108194 A1
(43) Pub. Date: Apr. 7, 2022

(54) PRIVATE SPLIT CLIENT-SERVER INFERENCING

(71) Applicant: QUALCOMM Incorporated, San Diego, CA (US)

(72) Inventors: Mohammad SAMRAGH RAZLIGHI, La Jolla, CA (US); Hossein HOSSEINI, San Diego, CA (US); Kambiz AZARIAN YAZDI, San Diego, CA (US); Joseph Binamira SORIAGA, San Diego, CA (US)

(21) Appl. No.: 17/491,094

(22) Filed: Sep. 30, 2021

Related U.S. Application Data
(60) Provisional application No. 63/086,362, filed on Oct. 1, 2020.

(51) Int. Cl. G06N 5/04

(52) U.S. Cl. CPC G06N 5/04

(57) ABSTRACT

Certain aspects of the present disclosure provide techniques for inferencing with a split inference model, including: generating an initial feature vector based on a client-side split inference model component; generating a modified feature vector by modifying a null-space component of the initial feature vector; providing the modified feature vector to a server-side split inference model component on a remote server; and receiving an inference from the remote server.

### CROSS-REFERENCE TO RELATED APPLICATIONS

This Application claims the benefit of and priority to U.S. Provisional Patent Application No. 63/086,362, filed on Oct. 1, 2020, the entire contents of which are incorporated herein by reference.

### INTRODUCTION

Aspects of the present disclosure relate to privacy preserving inferencing with machine learning models.

Machine learning is generally the process of producing a trained model (e.g., an artificial neural network, a tree, or other structures), which represents a generalized fit to a set of training data. Applying the trained model to new data produces inferences, which may be used to gain insights into the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically detecting features (e.g., faces) within images.

A challenge with machine learning models, such as artificial neural network models, is their computational complexity. This complexity limits their usability in certain contexts, such as on relatively lower-powered edge processing devices, including mobile devices, “always-on” devices, internet of things (IoT) devices, distributed sensor devices, and the like. A seemingly straightforward solution to this challenge is to outsource the computational complexity to a remote, high-powered processing device, such as a remote server. However, this may require sending sensitive data, including, for example, personally identifiable information (PII) to the remote processing device. This represents not only a problem for the end user, but also for the “inference as a service” provider who may directly, or indirectly, use such data in ways that violate various privacy laws.

Accordingly, what is needed are methods for splitting the computational burden of inferencing using machine learning models, such as advanced neural network models, between a client device and a remote processing device while preserving privacy of the underlying data used by the remote processing device.

### BRIEF SUMMARY

Certain aspects provide a method of training a split inference model, comprising: training a first split inference model comprising a plurality of layers to predict an intended attribute; for each respective split of a plurality of splits in the first split inference model: training a second model based on a client-side component of the first split inference model formed by the respective split and a server-side component configured to predict an unintended attribute; and determining an accuracy of the second model; and selecting a split of the plurality of splits based an accuracy of an associated second model being below a first threshold accuracy.

Further aspects provide a method of inferencing with a split inference model, comprising: generating an initial feature vector based on a client-side split inference model component; generating a modified feature vector by modifying a null-space component of the initial feature vector; providing the modified feature vector to a server-side split inference model component on a remote server; and receiving an inference from the remote server.

Further aspects provide a method of inferencing with a split inference model, comprising: generating an initial feature vector based on a client-side split inference model component; determining a signal strength associated with each feature in a signal space of the initial feature vector; generating a modified feature vector omitting one or more features in the signal space of the initial feature vector having a signal strength less than a signal strength threshold; providing the modified feature vector to a server-side split inference model component on a remote server; and receiving an inference from the remote server.

Further aspects provide a method of training a split inference model, comprising: training a split inference model comprising a client-side inference component and a server-side inference component to predict an intended attribute; and tuning the client-side inference component using an objective function that discourages null-space features without modifying the server-side inference component.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example split-inference architecture.

FIG. 2 depicts an example method for iteratively testing a split inference model during training to determine a privacy preserving split point.

FIG. 3 depicts examples of signal-space content and null-space content generated based on image data.

FIG. 4 depicts an example method for improving privacy in split-inferencing using null-space removal.

FIG. 5 depicts an example method for improving privacy in split-inferencing using signal space modification.

FIG. 6 depicts an example process for training a split inference model using a null-space reducing objective function.

FIG. 7 depicts an example processing system that may be configured to perform the methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for performing privacy preserving split inferencing with machine learning models, such as neural network models.

The power of neural networks in automatic feature extraction allows their utilization in various applications. However, the hidden layers in a neural network model often extract features other than those related to the explicit task for which the neural network was trained. For instance, a network trained for gender classification extracts features that may also be used to identify race. Further, it has been shown that representations learned by neural network models may even be used to reconstruct the raw data. Such unintended information leakage is not desired when the data for inferencing is used beyond the data owner's local device, such as when the data owner sends the data to a remote inference service provider, such as a cloud service. Such “inference as a service” providers are becoming increasingly ubiquitous and power functionalities on devices of all sorts, including smart home and wearable devices as just a few common examples.

Herein, a supervised learning setting is considered wherein a split inference model M₁∘M₂ (where ‘∘’ indicates a concatenation of the models at a split point and thus y=M₂(M₁(x))) is trained via a set of samples {xₙ}ₙ₌₁^{N} and their corresponding public attributes (or labels) {yₙ^{pub}}ₙ₌₁^{N}. Each sample also has one or more private attributes {yₙ^{pri}}ₙ₌₁^{N} that should not be exposed. The public attributes may be considered intended information for the inferencing process, whereas the private attributes are unintended information.

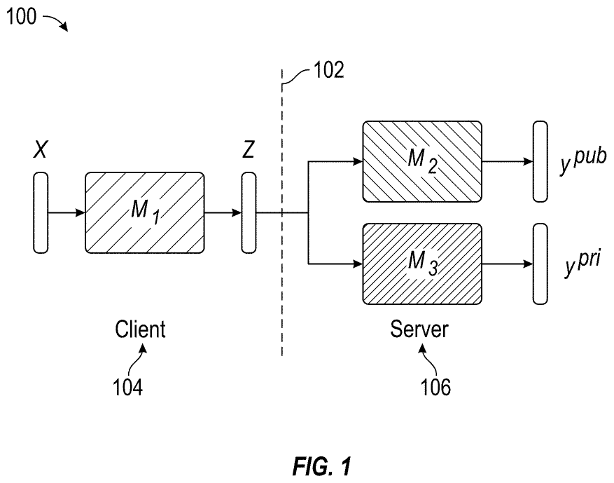

At the inference phase, a client 104 computes z=M₁(x) locally and queries the server 106 to compute y^{pub}=M₂(z), as depicted in FIG. 1. Ideally, training of the split inference model should result in the server being able to extract y^{pub}=M₂(z) with high accuracy, while maintaining privacy, which means information about y^{pri} should not be contained in z.

Various approaches have tried to address the information leakage problems presented in split inferencing contexts, such as where information about y^{pri} is contained in z. For example, one approach is to obfuscate private attributes by adding noise to the features. So, for example, instead of sending z to the server 106, the client sends z+μ (where μ represents added noise) such that M₂(z+μ)≈M₂(z). While noise addition can provide privacy to some extent, it reduces public attribute (y^{pub}) accuracy.

Another approach utilizes the information-theoretic concept of mutual information to provide privacy. For example, let I(a, b) denote the mutual information between random variables a and b. Then, train M₁ to maximize I(z, y^{pub}) while minimizing I(z, y^{pri}). However, since mutual information is merely a proxy for privacy, practical attacks can extract secret information even if I(z, y^{pri}) is minimized.

Yet another approach is adversarial training in which an adversarial game is formulated and the goal of the game is to solve the following min-max optimization:

$${max}_{{M}_{1} , {M}_{2}} {min}_{{M}_{3}} {𝔼}_{x , {y}^{pub} , {y}^{pri}} [ γℒ ( {y}^{pri} , {M}_{1} ∘ {M}_{3} ( x ) ) - ℒ ( {y}^{pub} , {M}_{1} ∘ {M}_{2} ( x ) ) ] \qquad ( 1 )$$

where [symbol] denotes the cross-entropy loss and γ is a controlling parameter. The objective in Equation 1 can be achieved through adversarial training, wherein at convergence, the trained M₁ generates z such that M₃(z) is not an accurate estimation of y^{pri} while M₂(z) accurately describes y^{pub}. However, the effectiveness of this adversarial approach relies on the uniqueness of M₃. Consequently, after adversarial training convergence, if M₃ is not unique, an alternative M_{3′} can be trained on top of the (fixed) M₁ to extract y^{pri}, breaking the privacy of the system.

Several issues exist with the aforementioned approaches. First, the underlying assumption in all aforementioned approaches is that a black-list of labeled private attributes (y^{pri}) are provided at training time. In reality, identifying this black-list and annotating the data to explicitly identify the private attributes hinders practical deployment. Second, the aforementioned approaches require re-training M₁ when a new private attribute is identified, which requires the new M₁ parameters to be redistributed among all clients, thus leading to potentially high communication costs. Third, deploying the aforementioned approaches often provides privacy at the expense of degradation in public attribute (y^{pub}) prediction accuracy.

Embodiments described herein overcome the shortcomings of existing approaches in several aspects.

First, embodiments introduce a training scheme for selecting a split point for a split inference model based on one or more criteria, including accuracy of an adversarial model that attempts to predict private attributes based on output of a client-side split inference model component and/or the desired level of computational complexity at the client device.

Second, embodiments described herein introduce the concept of null-space features in neural network layers. Informally, the null-content of z is any information in z that is not used by M₂ to perform the main task (i.e., the task for which M₂ is being explicitly trained, such as predicting a public attribute (y^{pub})). Thus, by definition, cleansing the null-space content does not affect utility of the model. Beneficially, removing null-space content from z limits an adversary's ability to extract private attributes.

Notably, the null-space content is defined regardless of the private attributes to be filtered out from z, which means the filtering can be performed without known the private attributes beforehand. Further, the null-space identification can be performed post-training, i.e., when the original split inference model M₁∘M₂ is trained on the server. This approach allows fast adaptation and provides users of cloud-based inference with a tradeoff between computation load, accuracy, and privacy.

Third, embodiments described herein provide for modifying the signal space component of the client-side split inference model component output in order to further obfuscate private attributes. The amount of signal space modification is tunable based on the level of privacy desired by the client.

Fourth, embodiments described herein provide an objective function for training a split inference model to inherently remove null-space features so that the signal space need not be derived by client or server explicitly.

Thus, the various embodiments described herein provide a flexible framework for privacy preserving split-inferencing between a client processing device (e.g., edge device) and a server processing device. Beneficially, this framework provides tunable trade-offs between client-side computation, privacy, and accuracy of the task for which a machine learning model was explicitly trained.

### Split-Inference Architecture for Determining Privacy-Inducing Model Splits

FIG. 1 depicts an example split-inference architecture 100 for determining privacy-inducing model splits.

Generally, in architecture 100, a client device 104 runs a client-side component M₁ of a split inference model M at inference time and sends the resulting feature vector z=M₁(x) to the server 106. The server the runs a server-side component M₂ of the split inference model M to predict the intended attribute as y^{pub}=M₂(z). By, running part of the model (M₁ in this example) at the edge, the client can obfuscate the raw data and save communication bandwidth.

Notably, to preserve privacy, the client desires z to only contain information related to the underlying task of predicting y^{pub}. Accordingly, the client can use architecture 100 to iteratively test different model split points 102 to determine the best tradeoff between client device processing load and privacy, where, generally speaking, the deeper (in terms of layers) the cut in a multi-layer model, the more privacy is preserved, but the more processing that must be done locally.

In order to perform the iterative testing, a first model M may be trained based on M₁∘M₂ (where ‘∘’ indicates a concatenation of the models at split point 102) to predict an intended attribute y^{pub} based on input x. Then a plurality of second models M′ may be trained based on M₁∘M₃, where M₁ and M₃ vary based on the split point 102, to predict an unintended or provate attribute y^{pri}. Based on these iterative tests, a split point 102 may be selected based on, for example, the accuracy of M′ falling below a threshold. Further, the computational complexity of M₁ may be considered as a further factor when balancing the client-side computational demand with privacy. In some cases, the split point may be dynamically selected based on a dynamic privacy need, which may change based on context, application use, and many other factors.

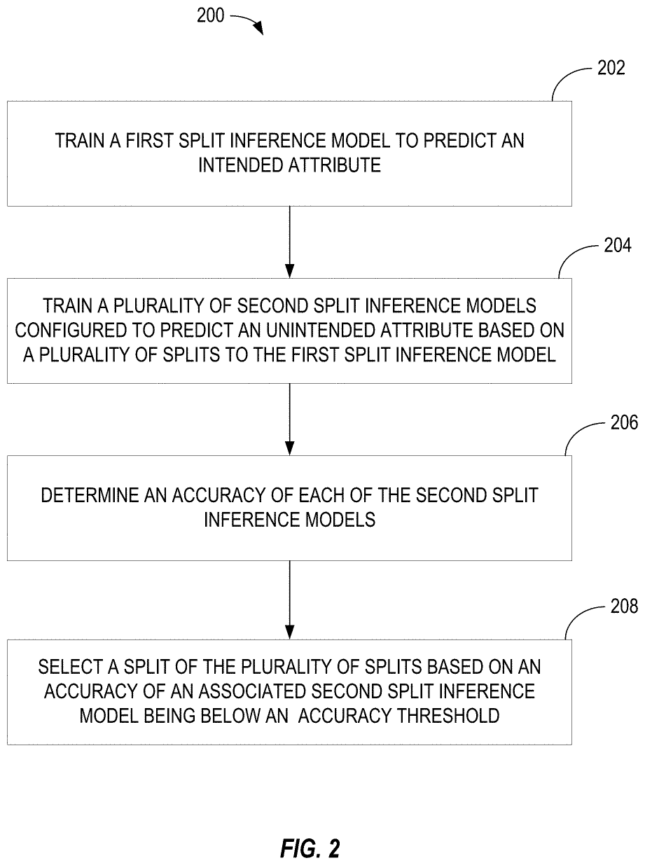

FIG. 2 depicts an example method 200 for iteratively testing a split inference model during training to determine a privacy preserving split point.

Method 200 begins at step 202 with training a first split inference model (e.g., M) to predict an intended (e.g., public) attribute (e.g., y^{pub}). For example, in the context of FIG. 1, a second split inference model may be M₁∘M₂. The first split inference model may comprise a plurality of layers, including linear and non-linear layers, such as convolution layers.

Method 200 then proceeds to step 204 with training a plurality of second split inference models (e.g., M′) configured to predict an unintended (e.g., private) attribute (e.g., y^{pri}) based on a plurality of splits (e.g., split 102 in FIG. 1) to the first split inference model. For example, in the context of FIG. 1, a second split inference model may be M₁∘M₃.

Method 200 then proceeds to step 206 with determining an accuracy of each of the second split inference models (M′), wherein the accuracy of each of the second split inference models is based on its ability to predict the unintended attribute (e.g., y^{pri}).

Method 200 then proceeds to step 208 with selecting a split of the plurality of splits based on an accuracy of an associated second split inference model (e.g., as defined by the selected split) being below an accuracy threshold. In some embodiments, the selected split may correspond with an associated split inference model that has the lowest accuracy for predicting the unintended attribute.

In other embodiments, selecting the split may further be based a computational burden on the client, which may also be compared to a threshold. In some cases, the threshold (representing tradeoffs between computational complexity at the client device and privacy) may result in a range of possible splits. In some cases, different splits may be chosen within such a range based on other context-specific factors, such as communication costs based on the different splits.

### Null-Space Feature Identification and Removal

Notwithstanding a split selected to maximize privacy, as described above with respect to FIG. 2, an adversary may still try to train a model M₃ to extract private attributes from the transmitted features z, such as y^{pri}=M₃ (Z). For example, if a client is sending voice data for voice-based authentication (y^{pub}), an adversary may try to train a model to predict private attributes (y^{pri}) such as age, gender, race, or the like based on the voice data, which are note necessary for the main task of authenticating the user by voice.

As depicted in FIG. 1, a feature vector z may be sent to the server 106 during a split inference process. Generally, z includes information that is not important for performing the main task (i.e., the task for which M₂ is being explicitly trained). As above, this information may be referred to as a null-space component of the feature vector z. Removing the null-space component does not affect the performance of the split inference model for the main task because it is not used for the main task, but it does beneficially limit the ability to extract unintended attributes (e.g., by M₃ in FIG. 1.)

More formally, a feature vector z in a feature space [symbol] ⁿ may be decomposed into a signal space component ( [symbol] ⊆ [symbol] ⁿ) and a null-space component ( [symbol] ⊂ [symbol] ⁿ), such that [symbol] ∪ [symbol] = [symbol] ⁿ and [symbol] ∩ [symbol] =∅. Accordingly, the feature vector z can then be interpreted as the summation of signal-space and null-space components, such that the feature vector z= [symbol] + [symbol] . As described further herein, a neural network may be trained to filter out null-space content [symbol] while predicting the intended attribute, so that in effect M₂(z)=M₂( [symbol] + [symbol] )=M₂( [symbol] ).

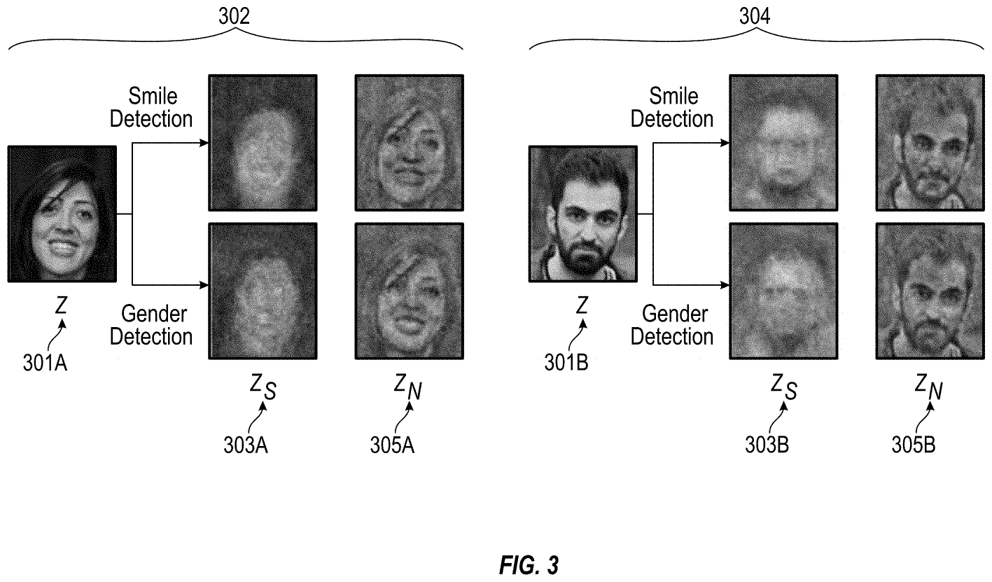

FIG. 3 depicts two examples (302 and 304) of decomposing a feature vector z (301A and 3013B) into signal space components [symbol] (303A and 303B) and null-space components [symbol] (305A and 305B) for two different classification tasks—smile detection and gender detection in this example. Here, the existence of a smile in the input image may be considered a public attribute while the gender of a person in the input image may be considered a private attribute. Notably, the null-space components [symbol] in both examples contain a large quantity of feature information that is unrelated to smile detection and gender detection, and which may be used to predict private, unintended attributes, such as age or race.

In one embodiment, [symbol] and [symbol] may be identified via a Singular Value Decomposition (SVD) of weight matrices in convolutional and fully-connected layers of a neural network model. For example, let z∈ [symbol] ⁿ be the feature vector, and W∈ [symbol] ^{m×n} be the weight matrix of the first layer of M₂ (server-side model, as in FIG. 1). As above, the feature vector may be decomposed as z= [symbol] + [symbol] , with the first and second components denoting the signal-space ( [symbol] ) and null-space ( [symbol] ) contents of z, respectively. The output of the first layer of M₂ is computed as y=W·z.

Let U·S·V denote the SVD of W. Since the rows of V form an orthonormal basis, the feature may be rewritten as:

z=Σᵢ₌₁ⁿαᵢvᵢ^{T}, αᵢ=<vᵢ^{T}, z>, (2)

where vᵢ^{T} is the transpose of the i-th row of V, αᵢ are projection coefficients, and the <⋅,⋅> operator denotes an inner-product.

The signal-space ( [symbol] ) and null-space ( [symbol] ) content of z are thus given as:

[symbol]

=Σᵢ₌₁^{m}αᵢvᵢ^{T}, [symbol] =Σᵢ₌ₘ₊₁ⁿαᵢvᵢ^{T}, (3)

where in Equation 3 above, it is assumed that the projection coefficients αᵢ are ordered by value. From Equations 2 and 3, it is clear that z= [symbol] + [symbol] .

In order to show that W· [symbol] =0, consider:

$$W \cdot {z}_{𝒩} = W \cdot {\sum }_{i = m + 1}^{n} {α}_{i} {v}_{i}^{T} = {\sum }_{i = m + 1}^{n} {α}_{i} W \cdot {v}_{i}^{T} = {\sum }_{i = m + 1}^{n} {α}_{i} U \cdot S \cdot {\underbrace{V \cdot {v}_{i}^{T}}}_{{q}_{i} ∈ {ℝ}^{n}} \qquad ( 4 )$$

By definition of SVD, the rows of V are orthonormal. Therefore, qᵢ=V·vᵢ^{T} is a one-hot vector:

$${q}_{i} = \{ \begin{matrix}< {v}_{j}^{T} , {v}_{i}^{T} > = 0 & j \neq i \\ < {v}_{i}^{T} , {v}_{i}^{T} > = 1 & \end{matrix} \qquad ( 5 )$$

Substituting qᵢ in Equation 4 yields:

W· [symbol] =Σᵢ₌ₘ₊₁ⁿαᵢU·S·qᵢ=Σᵢ₌ₘ₊₁ⁿαᵢU·S_{[:,i]}, (6)

where S_{[:,i}] is the i-th column of S (which is a diagonal matrix). And since S_{[:,i]}=0 for all i>m, then W· [symbol] =0

Accordingly, by definition, [symbol] + [symbol] =z. A large magnitude of [symbol] means that z encloses extra information that are disregarded by the main neural network (e.g., such as shown in the example of FIG. 3).

In order to promote privacy while maintaining the utility of a split inference model, the null-space component ( [symbol] ) may be altered or removed.

In one example, a client may alter the null-space and send modified activations zₒ=z+μ to the server, where μ∈ [symbol] is a random vector in the null-space. In this case, the added noise μ makes modified activations zₒ “noisy activations.” In such a case, an adversary can recover [symbol] as [symbol] =V_{1:m}^{T}·V_{1:m}·zₒ , but cannot recover [symbol] . Notably, because μ is independent of z, the client may compute it offline (e.g., when the client device is powered on but not in use) and then store the generated random vector for later use.

Alternatively, the client can compute the signal space of z directly (such as by the SVD method above), extract [symbol] , and send modified activations zₒ= [symbol] directly to the server. For example, consider z=[1,2,3], which is the sum of [symbol] =[2,1,0] and [symbol] =[−1,1,3] (because [symbol] + [symbol] =z). Then in this example, the modified activations are defined as zₒ= [symbol] , and thus zₒ=[2,1,0] is sent to the server. This approach does not require storage of the random vector components on the client device, but it does require extra computation during inference to extract [symbol] . However, as described further below, this extra overhead can be mitigated.

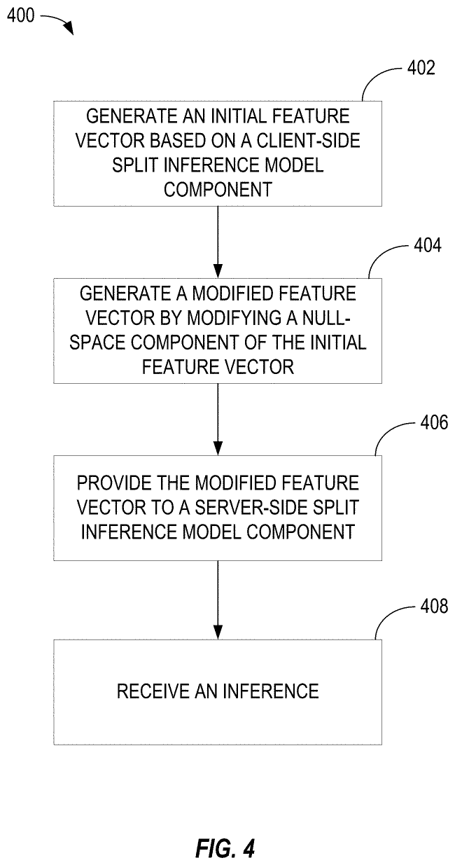

FIG. 4 depicts an example method 400 for improving privacy in split-inferencing using null-space removal.

Method 400 begins at step 402 with generating an initial feature vector (e.g., z in FIG. 1) based on a client-side split inference model component (e.g., M₁ in FIG. 1).

Method 400 then proceeds to step 404 with generating a modified feature vector by modifying a null-space component (e.g., [symbol] of FIG. 2) of the initial feature vector.

In some embodiments of method 400, modifying the null-space component comprises determining the null-space component via a singular value decomposition, as described above.

In some embodiments of method 400, modifying the null-space component comprises modifying a plurality of null-space features with randomly generated noise (e.g., zₒ=z+μ as described above).

In some embodiments of method 400, modifying the null-space component comprises removing a plurality of null-space feature values from the initial feature vector (e.g., zₒ= [symbol] as described above).

Method 400 then proceeds to step 406 with providing the modified feature vector to a server-side split inference model component (e.g., M₂ in FIG. 1) on a remote server.

In some embodiments of method 400, providing the modified feature vector to the server-side split inference model component on the remote server comprises providing the modified feature vector to a linear layer of the server-side split inference model.

In some embodiments of method 400, providing the modified feature vector to the server-side split inference model component on the remote server comprises providing the modified feature vector to a convolution layer of the server-side split inference model.

Method 400 then proceeds to step 408 with receiving an inference (e.g., a prediction of a public attribute, y^{pub}, as in FIG. 1) from the remote server.

### Modifying Signal Space Content to Enhance Privacy

Even after removing null-space content from a feature vector, some unintended information might remain embedded in the signal space vector z,45 . For example, this may happen when features are highly correlated across multiple prediction tasks, including the intended prediction task. In such cases, additional privacy may be provided by removing information from the signal space at the cost of lowering inference accuracy on the intended task.

For a linear layer, following the same process as above, the output is computed as:

W·z=W· [symbol] =Σᵢ₌₁^{m}αᵢU·S·qᵢ=Σᵢ₌₁^{m}αᵢU·S_{[:,i]}=Σᵢ₌₁^{m}sᵢαᵢU_{[:,i]}, (7)

where sᵢ is the i-th eigenvalue in S, αᵢ is defined above in Equation 2, and U_{[:,i]} denotes the i-th column of U.

From Equation 7, it is observable that components with larger sᵢ are contributing more to the layer output since ∥U_{[:,i]}∥₂=1 for all columns of U. As such, the signal-space content can be obfuscated by only computing the first m′<m elements in the summation of Equation 7 (assuming sᵢ are sorted in decreasing order of value).

Note that sᵢ and U_{[:,i]} are fixed at the inference time, thus, the client only computes and sends [α₁, . . . , α_{m′}] to the server. In fact, by choosing m′<<m, the client beneficially reduces the required bandwidth for the split inferencing procedure. The server knows sᵢ and U and computes the right hand side of Equation 7. The server knows W and can compute the singular value decomposition of W. Thus, after receiving α₁, . . . , α_{m′}, the server can compute W·z according to Equation 7.

Accordingly, modifying the signal space to enhance privacy may be performed by performing a singular value decomposition on the weight matrix that follows an activation z, e.g., in the first layer of the client-side split inference model component, where y=Wz with W∈R^{m×n} and W=USV, where U, S and V are the singular value decomposition of W.

Next, z is projected onto a subset of eigenvectors of the singular value decomposition. Thus, Wz=Σᵢ₌₁^{m}sᵢαᵢU_{[:,i]}, where αᵢ=<vᵢ^{T}, z> and vᵢ^{T} is the transpose of the i-th row of V. Notably, here it is assumed that sᵢ are sorted in decreasing order. Further, the subset comprises m′<m elements of Wz.

Finally, the projected vector is sent to the server for the server-side inference component.

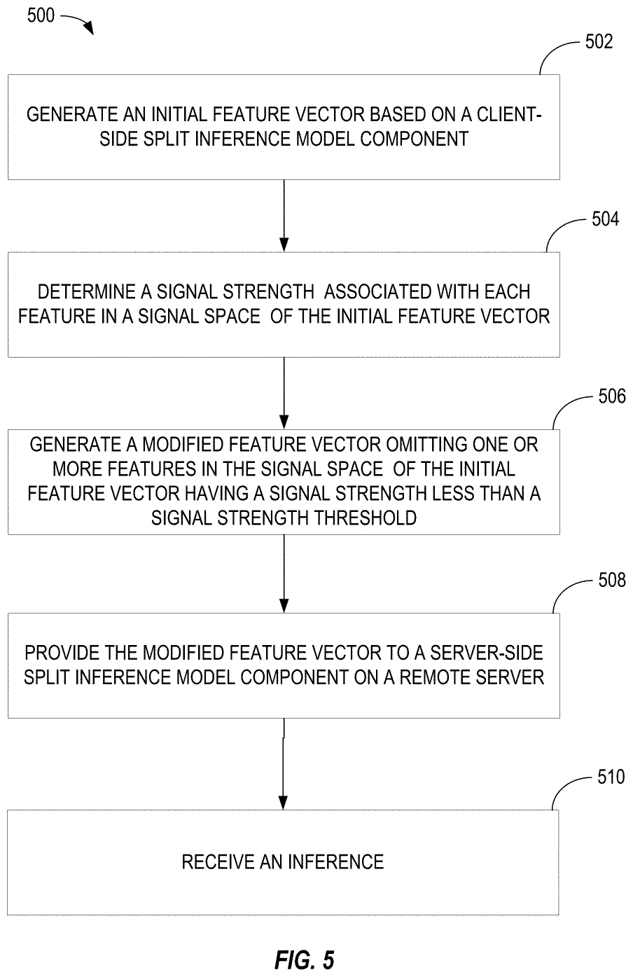

FIG. 5 depicts an example method 500 for improving privacy in split-inferencing using signal space modification.

Method 500 begins at step 502 with generating an initial feature vector (e.g., z in FIG. 1) based on a client-side split inference model component (e.g., M₁ in FIG. 1).

Method 500 then proceeds to step 504 with determining a signal strength (e.g., sᵢ) associated with each feature in a signal space of the initial feature vector.

In some embodiments of method 500, determining the signal space of the initial feature vector comprises performing a singular value decomposition, as described above.

In some embodiments of method 500, determining the signal strength associated with each feature in the signal space of the initial feature vector comprises performing a singular value decomposition on a weight matrix of the client-side split inference model component (e.g., the weight matrix following z).

Method 500 then proceeds to step 506 with generating a modified feature vector omitting one or more features in the signal space of the initial feature vector having a signal strength less than a signal strength threshold. As above, this may be accomplished by projecting the feature vector z to a reduced feature space based on the results of the singular value decomposition.

For example, consider s₁=10, s₂=2, and s₃=1 and zₛ=z₁+z₂+z₃, where: zₛ=[0,1,9], z₁=[1,5,2], z₂=[−1,0,4], and z₃=[0,−4,3]. If the signal strength threshold were 5, then because s₂ and s₃ are less than 5, z₂ and z₃ are discarded from zₛ, and only zₛ=z₁ is sent to the server.

Method 500 then proceeds to step 508 with providing the modified feature vector to a server-side split inference model component on a remote server.

In some embodiments of method 500, providing the modified feature vector to the server-side split inference model component on the remote server comprises providing the modified feature vector to a linear layer of the server-side split inference model.

In some embodiments of method 500, providing the modified feature vector to the server-side split inference model component on the remote server comprises providing the modified feature vector to a convolution layer of the server-side split inference model.

Method 500 then proceeds to step 510 with receiving an inference (e.g., y^{pub} in FIG. 1) from the remote server.

### Training Null-Free Features

Above it was described how the signal space of a feature vector [symbol] can be separated by performing a singular value decomposition and then computing {αᵢ}ᵢ₌₁^{m}. However, it is beneficial (complexity-wise) to avoid computing αᵢ so that z can be directly used for inference while maintaining privacy of z. One method to achieve this objective is by fine-tuning a pre-trained model (e.g., a neural network model) such that z is already projected into the signal-space [symbol] and does not require identification and removal of the null-space signal [symbol] .

To this end, the signal-space content may be quantified as

$${C}_{S} ( z ) = \frac{{‖ {z}_{S} ‖}^{2}}{{‖ z ‖}^{2}}$$

and the null-space content may be quantified as

$${C}_{𝒩} ( z ) = \frac{{‖ {z}_{𝒩} ‖}^{2}}{{‖ z ‖}^{2}}$$

Note that [symbol] (z)+ [symbol] (z)=1 for any arbitrary z. As such, pushing [symbol] (z) towards 1 will push the the null-space content towards 0, resulting in a network with “cleansed” z. The following is an objective function for fine-tuning:

$${min}_{{M}_{1}} {𝔼}_{x , y} {\underbrace{ℒ ( {M}_{2} ∘ {M}_{1} ( x ) , y )}}_{cross - entropy} + γ \underbrace{[ 1 - {C}_{S} ( {M}_{1} ( x ) ) ]}_{null - space} , \qquad ( 8 )$$

where z is the feature computed on the client side and γ is a trade-off parameter. Note that the above fine-tuning process takes place after an end-to-end model M=M₁∘M₂ is trained. During fine-tuning, M₂ is frozen and only M₁ is trained so that the null-space of M₂ does not vary.

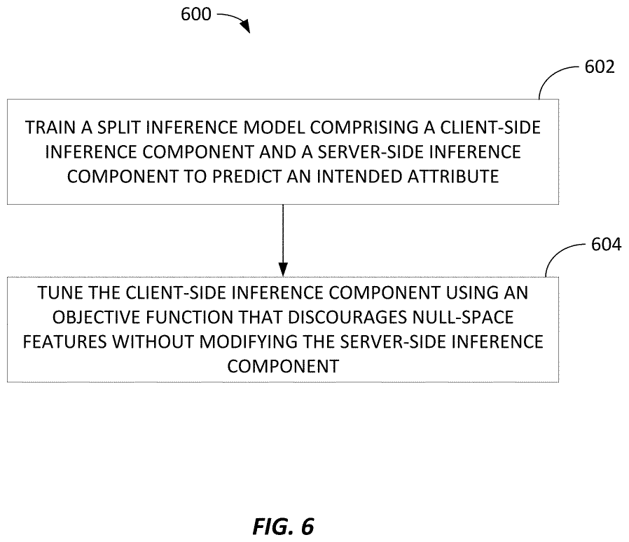

FIG. 6 depicts an example process 600 for training a split inference model using a null-space reducing objective function.

Method 600 begins at step 602 with training a split inference model comprising a client-side inference component and a server-side inference component to predict an intended attribute.

Method 600 then proceeds to step 604 with tuning the client-side inference component using an objective function that discourages null-space features without modifying the server-side inference component. In some embodiments, the objective function is Equation 8, above.

In some embodiments, method 600 further comprises deploying the tuned client-side inference component to a client device; and deploying a server-side inference component to a server.

### Combinability of the Various Optimizations and Application Specific Tuning

The aforementioned methods of training and inferencing with a split-inference model to preserve and enhance privacy, including with respect to FIGS. 2, 4, 5, and 6 may be combined in any combination. While described separately for clarity, they are generally complementary methods.

Some of the methods described above provide tradeoffs between model accuracy (e.g., for predicting an intended attribute), privacy, and efficiency (e.g., in terms of client-side computational complexity). For example, for a given client-side computation budget, there is a tradeoff between privacy and accuracy, i.e., higher privacy requirement results in lower accuracy. For a given privacy requirement, there is a tradeoff between accuracy and computation efficiency. And or a given accuracy requirement, there is a tradeoff between privacy and computation efficiency.

Beneficially, clients can tune what level of each feature (accuracy, privacy, and efficiency) they want to achieve, for example, by choosing how many layers of a model to process client-side and how much content from the signal-space to send to the server. Moreover, different combinations of these features can be selected in context and/or application specific ways. For example, an image-based facial authentication function on a client device may be tuned for more privacy, whereas a voice-based authentication system may be tuned for less privacy based on the assumption that fewer private attributes can be obtained.

### Example Processing System

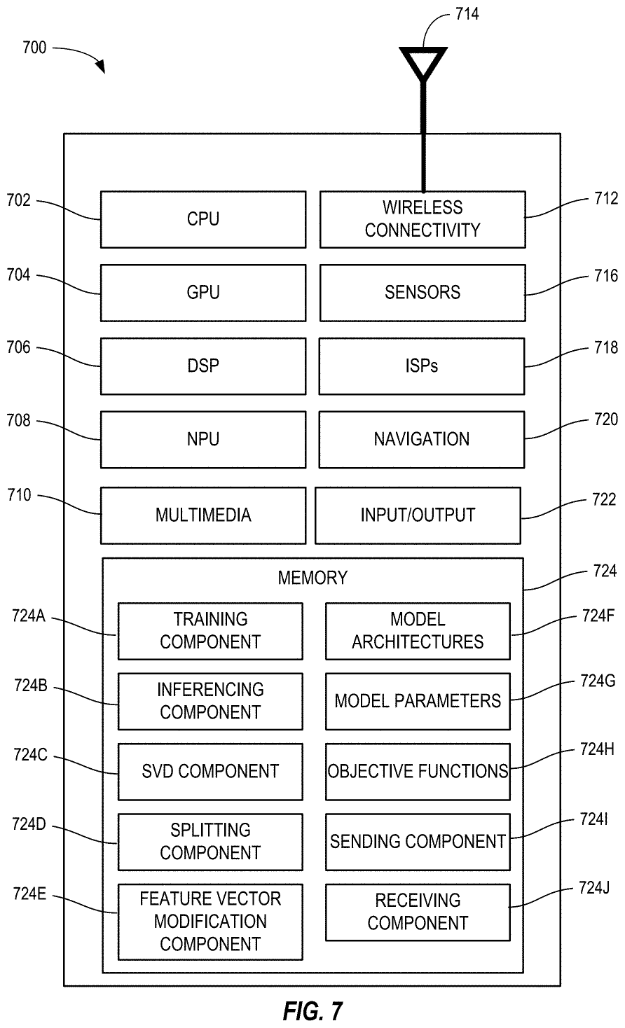

FIG. 7 depicts an example processing system 700 that may be configured to perform the methods described herein, such with respect to FIGS. 2 and 4-6.

Processing system 700 includes a central processing unit (CPU) 702, which in some examples may be a multi-core CPU. Instructions executed at the CPU 702 may be loaded, for example, from a program memory associated with the CPU 702 or may be loaded from a memory partition 724.

Processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as 708, is generally a specialized circuit configured for implementing all the necessary control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

NPUs, such as 708, may be configured to accelerate the performance of common machine learning tasks, such as image classification, machine translation, object detection, and various other tasks. In some examples, a plurality of NPUs may be instantiated on a single chip, such as a system on a chip (SoC), while in other examples they may be part of a dedicated machine learning accelerator device.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In some embodiments, NPU 708 may be implemented as a part of one or more of CPU 702, GPU 704, and/or DSP 706.

In some embodiments, wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 712 is further connected to one or more antennas 714.

Processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS) as well as inertial positioning system components.

Processing system 700 may also include one or more input and/or output devices 722, such as screens, touch-sensitive surfaces (including touch-sensitive displays), physical buttons, speakers, microphones, and the like.

In some examples, one or more of the processors of processing system 700 may be based on an ARM or RISC-V instruction set.

Processing system 700 also includes memory 724, which is representative of one or more static and/or dynamic memories, such as a dynamic random access memory, a flash-based static memory, and the like. In this example, memory 724 includes computer-executable components, which may be executed by one or more of the aforementioned components of processing system 700.

In particular, in this example, memory 724 includes training component 724A, inferencing component 724B, singular value decomposition (SVD) component 724C, splitting component 724D, feature vector modification component 724E, model architectures 724F, model parameters 724G, objective functions 724H, sending component 724I, and receiving component 724J. One or more of the depicted components, as well as others not depicted, may be configured to perform various aspects of the methods described herein.

Generally, processing system 700 and/or components thereof may be configured to perform the methods described herein.

Notably, in other embodiments, aspects of processing system 700 may be omitted, such as where processing system 700 is a server. For example, multimedia component 710, wireless connectivity 712, sensors 716, ISPs 718, and/or navigation component 720 may be omitted in other embodiments. Further, aspects of processing system 700 maybe distributed, such as between a client and a server in a split inferencing architecture.

Further, in other embodiments, various aspects of methods described above may be performed on one or more processing systems.

### Example Clauses

Implementation examples are described in the following numbered clauses:

Clause 1: A method of inferencing with a split inference model, comprising: generating an initial feature vector based on a client-side split inference model component; generating a modified feature vector by modifying a null-space component of the initial feature vector; providing the modified feature vector to a server-side split inference model component on a remote server; and receiving an inference from the remote server.

Clause 2: The method of Clause 1, wherein modifying the null-space component comprises determining the null-space component via a singular value decomposition.

Clause 3: The method of Clause 2, wherein modifying the null-space component comprises modifying a plurality of null-space features with randomly generated noise.

Clause 4: The method of Clause 2, wherein modifying the null-space component comprises removing a plurality of null-space feature values from the initial feature vector.

Clause 5: The method of any one of Clause 2 1-4, wherein providing the modified feature vector to the server-side split inference model component on the remote server comprises providing the modified feature vector to a linear layer of the server-side split inference model component.

Clause 6: The method of any one of Clauses 1-5, wherein providing the modified feature vector to the server-side split inference model component on the remote server comprises providing the modified feature vector to a convolution layer of the server-side split inference model component.

Clause 7: A method of inferencing with a split inference model, comprising: generating an initial feature vector based on a client-side split inference model component; determining a signal strength associated with each feature in a signal space of the initial feature vector; generating a modified feature vector omitting one or more features in the signal space of the initial feature vector having a signal strength less than a signal strength threshold; providing the modified feature vector to a server-side split inference model component on a remote server; and receiving an inference from the remote server.

Clause 8: The method of Clause 7, wherein determining the signal space of the initial feature vector comprises performing a singular value decomposition.

Clause 9: The method of any one of Clauses 7-8, wherein determining the signal strength associated with each feature in the signal space of the initial feature vector comprises determining a signal space component via a singular value decomposition on a weight matrix of the client-side split inference model component.

Clause 10: The method of any one of Clauses 7-9, wherein providing the modified feature vector to the server-side split inference model component on the remote server comprises providing the modified feature vector to a linear layer of the server-side split inference model component.

Clause 11: The method of any one of Clauses 7-10, wherein providing the modified feature vector to the server-side split inference model component on the remote server comprises providing the modified feature vector to a convolution layer of the server-side split inference model component.

Clause 12: A method of training a split inference model, comprising: training a first split inference model comprising a plurality of layers to predict an intended attribute; for each respective split of a plurality of splits in the first split inference model: training a second model based on a client-side component of the first split inference model formed by the respective split and a server-side component configured to predict an unintended attribute; and determining an accuracy of the second model; and selecting a split of the plurality of splits based an accuracy of an associated second model being below a first threshold accuracy.

Clause 13: The method of Clause 12, wherein selecting the split of the plurality of splits is further based on a computational complexity of a client-side component of the first split inference model associated with a selected split.

Clause 14: The method of any one of Clauses 12-13, further comprising: deploying a client-side component of the first split inference model formed by the selected split to a client device; and deploying a server-side component of the first split inference model formed by the selected split to a server.

Clause 15: A method of training a split inference model, comprising: training a split inference model comprising a client-side inference component and a server-side inference component to predict an intended attribute; and tuning the client-side inference component using an objective function that discourages null-space features without modifying the server-side inference component.

Clause 16: The method of Clause 15, wherein: the objective function is:

$${min}_{{M}_{1}} {𝔼}_{x , y} {\underbrace{ℒ ( {M}_{2} ∘ {M}_{1} ( x ) , y )}}_{cross - entropy} + γ \underbrace{[ 1 - {C}_{S} ( {M}_{1} ( x ) ) ]}_{null - space} ,$$

M₁ is the client-side inference component, M₂ is the server-side inference component, γ is a hyperparameter, x is an input, and y is an output.

Clause 17: The method of any one of Clauses 15-16, further comprising: deploying the tuned client-side inference component to a client device; and deploying a server-side inference component to a server.

Clause 18: A processing system, comprising: a memory comprising computer-executable instructions; and one or more processors configured to execute the computer-executable instructions and cause the processing system to perform a method in accordance with any one of Clauses 1-17.

Clause 19: A processing system, comprising means for performing a method in accordance with any one of Clauses 1-17.

Clause 20: A non-transitory computer-readable medium comprising computer-executable instructions that, when executed by one or more processors of a processing system, cause the processing system to perform a method in accordance with any one of Clauses 1-17.

Clause 21: A computer program product embodied on a computer-readable storage medium comprising code for performing a method in accordance with any one of Clauses 1-17.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of inferencing with a split inference model, comprising:
generating an initial feature vector based on a client-side split inference model component;
generating a modified feature vector by modifying a null-space component of the initial feature vector;
providing the modified feature vector to a server-side split inference model component on a remote server; and
receiving an inference from the remote server.

2. The method of claim 1, wherein modifying the null-space component comprises determining the null-space component via a singular value decomposition.

3. The method of claim 2, wherein modifying the null-space component comprises modifying a plurality of null-space features with randomly generated noise.

4. The method of claim 2, wherein modifying the null-space component comprises removing a plurality of null-space feature values from the initial feature vector.

5. The method of claim 1, wherein providing the modified feature vector to the server-side split inference model component on the remote server comprises providing the modified feature vector to a linear layer of the server-side split inference model component.

6. The method of claim 1, wherein providing the modified feature vector to the server-side split inference model component on the remote server comprises providing the modified feature vector to a convolution layer of the server-side split inference model component.

7. A processing system, comprising:
a memory comprising computer-executable instructions; and
a processor configured to execute the computer-executable instructions and cause the processing system to:
generate an initial feature vector based on a client-side split inference model component;
generate a modified feature vector by modifying a null-space component of the initial feature vector;
provide the modified feature vector to a server-side split inference model component on a remote server; and
receive an inference from the remote server.

8. The processing system of claim 7, wherein in order to modify the null-space component, the processor is further configured to determine the null-space component via a singular value decomposition.

9. The processing system of claim 8, wherein in order to modify the null-space component, the processor is further configured to modify a plurality of null-space features with randomly generated noise.

10. The processing system of claim 8, wherein in order to modify the null-space component, the processor is further configured to remove a plurality of null-space feature values from the initial feature vector.

11. The processing system of claim 7, wherein in order to provide the modified feature vector to the server-side split inference model component on the remote server, the processor is further configured to provide the modified feature vector to a linear layer of the server-side split inference model component.

12. The processing system of claim 7, wherein in order to provide the modified feature vector to the server-side split inference model component on the remote server, the processor is further configured to provide the modified feature vector to a convolution layer of the server-side split inference model component.

13. A non-transitory computer-readable medium comprising computer-executable instructions that, when executed by a processor of a processing system, cause the processing system to perform a method, the method comprising:
generating an initial feature vector based on a client-side split inference model component;
generating a modified feature vector by modifying a null-space component of the initial feature vector;
providing the modified feature vector to a server-side split inference model component on a remote server; and
receiving an inference from the remote server.

14. The non-transitory computer-readable medium of claim 13, wherein modifying the null-space component comprises determining the null-space component via a singular value decomposition.

15. The non-transitory computer-readable medium of claim 14, wherein modifying the null-space component comprises modifying a plurality of null-space features with randomly generated noise.

16. The non-transitory computer-readable medium of claim 14, wherein modifying the null-space component comprises removing a plurality of null-space feature values from the initial feature vector.

17. The non-transitory computer-readable medium of claim 13, wherein providing the modified feature vector to the server-side split inference model component on the remote server comprises providing the modified feature vector to a linear layer of the server-side split inference model component.

18. The non-transitory computer-readable medium of claim 13 wherein providing the modified feature vector to the server-side split inference model component on the remote server comprises providing the modified feature vector to a convolution layer of the server-side split inference model component.

19. A method of inferencing with a split inference model, comprising:
generating an initial feature vector based on a client-side split inference model component;
determining a signal strength associated with each feature in a signal space of the initial feature vector;
generating a modified feature vector omitting one or more features in the signal space of the initial feature vector having a signal strength less than a signal strength threshold;
providing the modified feature vector to a server-side split inference model component on a remote server; and
receiving an inference from the remote server.

20. The method of claim 19, wherein determining the signal space of the initial feature vector comprises performing a singular value decomposition.

21. The method of claim 19, wherein determining the signal strength associated with each feature in the signal space of the initial feature vector comprises determining a signal space component via a singular value decomposition on a weight matrix of the client-side split inference model component.

22. The method of claim 19, wherein providing the modified feature vector to the server-side split inference model component on the remote server comprises providing the modified feature vector to a linear layer of the server-side split inference model component.

23. The method of claim 19, wherein providing the modified feature vector to the server-side split inference model component on the remote server comprises providing the modified feature vector to a convolution layer of the server-side split inference model component.
